(19) United States
(12) Patent Application Publication
(10) Pub. No.: US 2024/0092960 A1
(43) Pub. Date: Mar. 21, 2024

(54) FLUORINE-FREE DYNAMIC WATER REPELLENTS WITH OIL-REPELLENT PROPERTIES, WATER-REPELLENT ARTICLES, AND METHODS OF MAKING THE SAME

(71) Applicant: 3M INNOVATIVE PROPERTIES COMPANY, St. Paul, MN (US)

(72) Inventors: Cheryl L. S. Elsbernd, Woodbury, MN (US); Richard J. Pokorny, Maplewood, MN (US); Chad M. Amb, Roberts, WI (US); Nicholas L. Untiedt, Minneapolis, MN (US)

(21) Appl. No.: 18/280,292

(22) PCT Filed: Jan. 18, 2022
(86) PCT No.: PCT/US2022/012760

§ 371 Date: Sep. 5, 2023

Related U.S. Application Data
(60) Provisional application No. 63/156,094, filed on Mar. 3, 2021.

(51) Int. Cl. C08F 283/12; C09D 5/16; C09D 151/08; D06M 15/263; D06M 15/643

(52) U.S. Cl. CPC C08F 283/124; C09D 5/1675; C09D 151/085; D06M 15/263; D06M 15/6433; D06M 2101/32

(57) ABSTRACT

A copolymer preparable by copolymerization of monomer components comprising: a) polydimethylsiloxane mono(meth)acrylate having a molecular weight of from 300 to 10000 grams/mole; b) optionally C₃-C₁₀ carboxylic acid-functional mono(meth)acrylate or a salt thereof; c) at least one C₅-C₁₆ hydroxyalkyl mono(meth)acrylate; and d) at least one of: i) C₁₀-C₃₀ linear alkyl mono(meth)acrylate optionally having one or two carbon atoms replaced by O or S; or ii) at least one (meth)acrylate represented by the formula wherein: R¹ is H or a C₁-C₄ alkyl group; n is an integer from 0 to 18, inclusive; each X is O, S, C₂-C₆ oxyalkylenoxy, C₂-C₆ thioalkylenethio, or a covalent bond; and R² is independently a C₅-C₅₀ hydrocarbyl group. The copolymer is useful as a water- and oil-repellent treatment on a substrate. Certain monomers corresponding to component ii) are also disclosed.

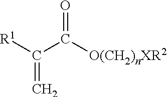

### BACKGROUND

Fluorochemicals have been widely used for more than fifty years as fabric treatments that provided durable stain release, oil and water repellency, and dynamic water repellency. However, due to environmental and health concerns, governmental agencies and nongovernmental organizations have lately been pushing the apparel market towards the use of fabric treatments that are produced with raw materials that do not contain fluorine. However, non-fluorinated fabric treatments developed to date have shown little or no ability to provide durable oil repellency.

### SUMMARY

Consequently, there is a need for a fluorine-free dynamic water-repellent fabric treatment with even a minimal degree of oil repellency.

In one aspect, the present disclosure provides a copolymer preparable by copolymerization of monomer components comprising:
a) at least one polydimethylsiloxane mono(meth)acrylate having a molecular weight of from 300 to 10000 grams/mole;
b) optionally at least one C₃-C₁₀ carboxylic acid-functional mono(meth)acrylate or a salt thereof;
c) at least one C₅-C₁₆ hydroxyalkyl mono(meth)acrylate; and
d) at least one of:
   i) at least one C₁₀-C₃₀ linear alkyl mono(meth)acrylate optionally having one or two carbon atoms replaced by O or S, with the proviso that no O—O, S—S, or S—O bonds are present; or
   ii) at least one (meth)acrylate represented by the formula

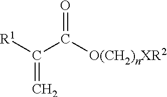

wherein:
   each R¹ is independently H or a C₁-C₄ alkyl group;
   each n is independently an integer from 0 to 18, inclusive;
   each X is independently O, S, C₂-C₆ oxyalkylenoxy, C₂-C₆ thioalkylenethio, or a covalent bond, with the proviso that if n=0, then X is a covalent bond; and
   each R² is independently a C₅-C₅₀ hydrocarbyl group optionally having 1 to 3 rings optionally collectively bound to one to four C₁-C₄ alkyl groups.

In another aspect, the present disclosure provides a method of making a copolymer, the method comprising:
combining a free-radical initiator with monomer components comprising:
   a) at least one polydimethylsiloxane mono(meth)acrylate having a molecular weight of from 300 to 10000 grams/mole;
   b) optionally at least one C₃-C₁₀ carboxylic acid-functional mono(meth)acrylate or a salt thereof;
   c) at least one C₅-C₁₆ hydroxyalkyl mono(meth)acrylate; and
   d) at least one of:
      i) at least one C₁₀-C₃₀ linear alkyl mono(meth)acrylate optionally having one or two carbon atoms replaced by O or S, with the proviso that no O—O, S—S, or S—O bonds are present; or
      ii) at least one (meth)acrylate represented by the formula

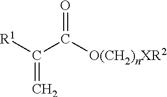

wherein:
   each R¹ is independently H or a C₁-C₄ alkyl group;
   each n is independently an integer from 0 to 18, inclusive;
   each X is independently O, S, C₂-C₆ oxyalkylenoxy, C₂-C₆ thioalkylenethio, or a covalent bond, with the proviso that if n=0, then X is a covalent bond; and
   each R² is independently a C₅-C₅₀ hydrocarbyl group optionally having 1 to 3 rings optionally collectively bound to one to four C₁-C₄ alkyl groups; and
decomposing the free-radical initiator and causing copolymerization of the monomer components.

In yet another aspect, the present disclosure provides a water-repellent article comprising a substrate having a non-fluorinated water-repellent treatment disposed on at least a portion thereof, wherein the non-fluorinated water-repellent treatment comprises a copolymer of monomer components comprising:
a) at least one polydimethylsiloxane mono(meth)acrylate having a molecular weight of from 300 to 10000 grams/mole;
b) optionally at least one C₃-C₁₀ carboxylic acid-functional mono(meth)acrylate or a salt thereof;
c) at least one C₅-C₁₆ hydroxyalkyl mono(meth)acrylate; and
d) at least one of:
   i) at least one C₁₀-C₃₀ linear alkyl mono(meth)acrylate optionally having one or two carbon atoms replaced by O or S, or
   ii) at least one (meth)acrylate represented by the formula

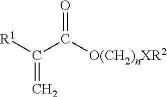

wherein:
   each R¹ is independently H or a C₁-C₄ alkyl group;
   each n is independently an integer from 0 to 18, inclusive;
   each X is independently O, S, C₂-C₆ oxyalkylenoxy, C₂-C₆ thioalkylenethio, or a covalent bond, with the proviso that if n=0, then X is a covalent bond; and
   each R² is independently a C₅-C₅₀ hydrocarbyl group optionally having 1 to 3 rings optionally collectively bound to one to four C₁-C₄ alkyl groups.

In some preferred embodiments, the substrate comprises at least one of a fabric, leather, or synthetic leather. In other preferred embodiments, the substrate may comprise metal, ceramic, glass, synthetic polymer, such as films.

In yet another aspect, the present disclosure provides a monomer represented by the formula

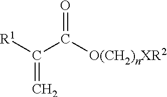

wherein:
   each R¹ is independently H or a C₁-C₄ alkyl group;
   each n is independently an integer from 4 to 18, inclusive;
   each X is independently O, S, C₂-C₆ oxyalkylenoxy, C₂-C₆ thioalkylenethio, or a covalent bond; and
   each R² is independently a C₅-C₅₀ hydrocarbyl group having 1 to 3 rings collectively bound to a total of one to four C₁-C₄ alkyl groups.

Copolymers according to the present disclosure exhibit water-repellency and at least some degree of oil-repellency, especially when applied to textiles.
As used herein:
the term “(meth)acryl” is equivalent to the term “(meth)acryloyl”;
the expression “Cₐ-C_{b}” means having from a to b carbon atoms, inclusive;
the phrase “preparable by” means that it can be, but is not necessarily prepared by;
the term “(meth)acryl” encompasses acryl and/or methacryl;
the term “copolymer” refers to a polymer derived from more than one species of monomer;
the term “copolymerization” refers to the polymerization of more than one species of monomer to form a copolymer;
the term “fabric” refers to a substantially two-dimensional web of entangled fibers, which may be woven, knitted, felted, braided, or nonwoven, for example;
the term “hydrocarbyl” means composed entirely of carbon and hydrogen atoms;
the term “leather” refers to a material made from the skin of an animal by tanning or a similar process;
the term “monomer” refers to a molecule (or a plurality of like molecules) that can react together, optionally with other different molecules, to form a larger polymer chain or three-dimensional network;
the term “nonwoven” excludes woven, knitted, and/or braided; and
the term “synthetic leather” refers to a material having the properties or appearance of leather, but that is not made of leather.

Features and advantages of the present disclosure will be further understood upon consideration of the detailed description as well as the appended embodiments.

### DETAILED DESCRIPTION

The present inventors have discovered through detailed study that a degree of oil repellency can be imparted to water-repellent silicone polymers by incorporating crystalline or rigid hydrophobic monomers. Without wishing to be bound by theory, the present inventors believe that methylated aromatic or cyclic monomers may tend to crystallize and orient to align the relatively lower surface energy methyl groups at the copolymer/air interface, thereby imparting a degree of oil-repellency. That is, the substrate is rated C or higher (C, B/C, B, A/B or A) according to the AATCC (The American Association of Textile Chemists & Colorists, Research Triangle Park, North Carolina) Test Method 118-2013 entitled “Oil Repellency: Hydrocarbon Resistance Test”, except using at least one test liquid reported in Table 3, hereinbelow.

Copolymers according to the present disclosure can be prepared, for example, by free-radical copolymerization of various monomer components as described herein. The monomer components comprise: at least one polydimethylsiloxane mono(meth)acrylate having a molecular weight of from 300 to 10000 grams/mole; b) optionally at least one of a C₃ to C₁₀ carboxylic acid-functional mono(meth)acrylate or a salt thereof; c) at least one C₅ to C₁₆ hydroxyalkyl mono(meth)acrylate; and d) at least one of: i) at least one C₁₀-C₃₀ linear alkyl mono(meth)acrylate optionally having one or two carbon atoms replaced by O or S, with the proviso that no O—O, S—S, or S—O bonds are present, or ii) at least one (meth)acrylate represented by the formula

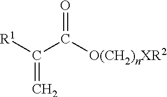

wherein each R¹ is independently H or a C₁-C₄ alkyl group; each n is independently an integer from 0 to 18, inclusive; each X is independently O, S, C₂-C₆ oxyalkylenoxy, C₂-C₆ thioalkylenethio, or a covalent bond, with the proviso that if n=0, then X is a covalent bond; and each R² is independently a C₅-C₅₀ hydrocarbyl group optionally having 1 to 3 rings optionally collectively bound to one to four C₁-C₄ alkyl groups.

In some embodiments, copolymers according to the present disclosure can be prepared, for example, by free-radical copolymerization of various monomer components selected from monomer components a)-d).

While any relative amounts of components a)-d) may be used, the copolymer often includes monomer units (i.e., monomeric units) in relative amounts corresponding to 5 to 35 weight percent (more preferably 10 to 30 weight percent, and even more preferably 15 to 25 weight percent) of monomer a); 0 to 12 weight percent (more preferably 4 to 10 weight percent, and even more preferably 5 to 9 weight percent) of monomer b); 5 to 30 weight percent (more preferably 10 to 20 weight percent, and even more preferably 15 to 20 weight percent) of monomer c); and 40 to 70 weight percent (more preferably 45 to 65 weight percent, and even more preferably 50 to 60 weight percent) of monomer d), based on a combined total weight of monomer components a), b), c), and d) of 100 weight percent.

As used herein, the term “polydimethylsiloxane mono(meth)acrylate” refers to a compound having a polydimethylsiloxane segment having one terminal group containing one (meth)acryloxy group, typically connected by a C₁ to C₅ alkylene group, and having a molecular weight of from 300 to 10000 grams/mole, preferably 600 to 7000 grams/mole. Often the opposite end of the polydimethylsiloxane segment is terminated by an alkyl group (typically having from 1 to 8 carbon atoms); however, this is not a requirement. Polydimethylsiloxane mono(meth)acrylates can be prepared, for example, from the corresponding mono-hydroxylalkylpolydimethylsiloxanes (e.g., by condensation with a suitable (meth)acrylic acid derivative (e.g., an ester or acid chloride) and/or obtained from a commercial source. Polydimethylsiloxane mono(meth)acrylates can also be produced from the anionic ring opening polymerization of cyclic polydimethylsiloxanes and quenching with an appropriate (meth)acryl functional silyl chloride (Shinoda et. al., Macromolecules 2001, 34, 10, p. 3186-3194). Polydimethylsiloxane mono(meth)acrylates can also be produced by the acid-catalyzed redistribution of (meth)acrylpropylalkoxysilanes with other silyl containing species (e.g., see PCT Publ. No. WO 2008/090013 A1(Jandke et al.)).

Commercially available polydimethylsiloxane mono(meth)acrylates include: poly(dimethylsiloxane), monomethacrylate terminated (4000-6000 grams/mole) (Cat. No. 798274) available from Sigma-Aldrich Co. Saint Louis, Missouri; alkyl-terminated monomethacrylated silicone fluids available in grades X-22-2404 (420 g/mol), X-22-174SX (900 g/mol), X-22-174BX (2300 g/mol), and KF-2012 (4600 g/mol) from Shin-Etsu Chemical Co., Ltd., Tokyo, Japan; and alkyl-terminated monomethacrylated polydimethylsiloxanes available in grades MCR-M07 (600-800 g/mol), MCR-M11 (800-1000 g/mol), MCR-M17 (5000 g/mol), and MCR-C22 (10000 g/mol) from Gelest Inc., Morrisville, Pennsylvania.

Useful C₃-C₁₀ carboxylic acid-functional mono(meth)acrylates (i.e., the entire carboxylic acid-functional mono(meth)acrylate has from 3 to 10 carbon atoms, inclusive) include, for example, (meth)acrylic acid, 2-(meth)acryloyloxyacetic acid, 3-(meth)acryloxypropanoic acid, 4-(meth)acryloxybutanoic acid, 5-(meth)acryloxypentanoic acid, 6-(meth)acryloxyhexanoic acid, 7-acryloxyheptanoic acid, mono-2-((meth)acryloyloxy)ethyl succinate, maleic acid, and C₁-C₈ monoalkyl esters of maleic acid. In some embodiments, C₃-C₈ carboxylic acid-functional mono(meth)acrylate, or C₃-C₅ carboxylic acid-functional mono(meth)acrylates are preferred. Of these, acrylic acid and methacrylic acid are most preferred in many embodiments. The C₃-C₁₀ carboxylic acid-functional mono(meth)acrylates may be linear or branched and/or cyclic, preferably linear. Carboxylic acid-functional mono(meth)acrylates may be obtained, for example, from commercial sources and/or synthesized by known methods. In many preferred embodiments, the carboxylic acid-functional mono(meth)acrylates are linear; however, this is not a requirement. In many preferred embodiments, the carboxylic acid-functional mono(meth)acrylates are free of heteroatoms (i.e., atoms other than C or H) other than the two of the (meth)acryloxy group; however, this is not a requirement. In many embodiments, the carboxyl group is disposed at an opposite end of a linear alkylene group from the (meth)acryloxy group.

Useful C₅-C₁₆ hydroxyalkyl mono(meth)acrylates (i.e., the entire hydroxyalkyl mono(meth)acrylate has from 5 to 16 carbon atoms, inclusive) include, for example 2-hydroxyethyl (meth)acrylate, 3-hydroxypropyl (meth)acrylate, 2-hydroxypropyl (meth)acrylate, 2-hydroxy-1-methylethyl (meth)acrylate, 4-hydroxybutyl (meth)acrylate, 5-hydroxypentyl (meth)acrylate, 6-hydroxyhexyl (meth)acrylate, 7-hydroxyheptyl (meth)acrylate, 8-hydroxyoctyl (meth)acrylate, 9-hydroxynonyl (meth)acrylate, 10-hydroxydecyl (meth)acrylate, 11-hydroxyundecyl (meth)acrylate, 12-hydroxydodecyl (meth)acrylate, and 13-hydroxytridecyl acrylate. In some embodiments, C₅-C₁₂ hydroxyalkyl mono(meth)acrylates, or C₅-C₈ hydroxyalkyl mono(meth)acrylates are preferred. Of these, mixtures of 2-hydroxypropyl (meth)acrylate, 2-hydroxy-1-methylethyl (meth)acrylate, hydroxypropyl (meth)acrylate , and hydroxybutyl (meth)acrylate are preferred in many embodiments. Hydroxyalkyl mono(meth)acrylates may be obtained, for example, from commercial sources and/or synthesized by known methods. In many preferred embodiments, the hydroxyalkyl mono(meth)acrylates are linear; however, this is not a requirement. In many preferred embodiments, the hydroxyalkyl mono(meth)acrylates are free of heteroatoms other than the three of the hydroxyl and (meth)acryloxy groups; however, this is not a requirement. In many embodiments, the hydroxyl group is disposed at an opposite end of a linear alkylene group from the (meth)acryloxy group.

Useful C₁₀-₃₀ linear alkyl mono(meth)acrylates (i.e., the entire linear alkyl (meth)acrylate has from 10 to 30 carbon atoms, inclusive) include, for example, heptyl (meth)acrylate, octyl (meth)acrylate, decyl (meth)acrylate, undecyl (meth)acrylate, dodecyl (meth)acrylate, tetradecyl (meth)acrylate, hexadecyl (meth)acrylate, octadecyl (meth)acrylate, icosyl (meth)acrylate, docosyl (i.e., behenyl) (meth)acrylate, tetracosyl (meth)acrylate, hexacosyl (meth)acrylate, and heptacosyl acrylate. In some embodiments, C₁₈ to C₃₀ linear alkyl mono(meth)acrylates, or C₂₀ to C₃₀ carboxylic acid-functional mono(meth)acrylates are preferred. Of these, octadecyl and behenyl (meth)acrylate are most preferred in many embodiments. Linear alkyl mono(meth)acrylates may be obtained, for example, from commercial sources and/or synthesized by known methods. In some embodiments, one or two O or S atoms may be incorporated in place of CH₂ group in the linear chain Useful examples include but are not limited to 2-dodecylsulfanylethyl (meth)acrylate, 4-dodecylsulfanylbutyl (meth)acrylate, 6-dodecylsulfanylhexyl (meth)acrylate, 7-dodecylsulfanylheptyl (meth)acrylate, 8-dodecylsulfanyloctyl (meth)acrylate, 11-dodecylsulfanylundecyl (meth)acrylate, 2-octylsulfanylethyl (meth)acrylate, 4-octylsulfanylbutyl (meth)acrylate, 6-octylsulfanylhexyl (meth)acrylate, 7-octylsulfanylheptyl (meth)acrylate, 8-octylsulfanyloctyl (meth)acrylate, 11-octylsulfanylundecyl (meth)acrylate, 2-dodecyloxylethyl (meth)acrylate, 4-dodecyloxybutyl (meth)acrylate, 6-dodecyloxyhexyl (meth)acrylate, 7-dodecyloxyheptyl (meth)acrylate, 8-dodecyloxyoctyl (meth)acrylate, 11-dodecyloxyundecyl (meth)acrylate, 2-octyloxyethyl (meth)acrylate, 4-octyloxybutyl (meth)acrylate, 6-octyloxyhexyl (meth)acrylate, 7-octyloxyheptyl (meth)acrylate, 8-octyloxyoctyl (meth)acrylate, 11-octyloxyundecyl (meth)acrylate.

Alternatively, or in addition to, the at least one C₁₀ to C₃₀ linear alkyl mono(meth)acrylate described above, the monomer components include at least one monomer component represented by the formula

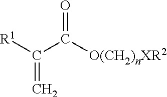

Each R¹ is independently H or a C₁ to C₄ alkyl group (e.g., methyl, ethyl, propyl, butyl).

Each n is independently an integer from 0 to 18, inclusive (i.e., 0, 1, 2, 3, 4, 5, 6, 7, 8, 9, 10, 11, 12, 13, 14, 15, 16, 17, or 18). In many embodiments, each n is independently from 6 to 18 inclusive.

Each X is independently O, S, C₂-C₆ oxyalkylenoxy (e.g,, oxyethylenoxy, oxypropyleneoxy, oxyisopropylenoxy, oxybutylenoxy, oxyisobutylenoxy, oxypentylenoxy, oxyhexylenoxy) C₂-C₆ thioalkylenethio (e.g,, thioethylenethio, thiopropylenethio, thioisopropylenethio, thiobutylenethio, thioisobutylenethio, thiopentylenethio, thiohexylenethio), or a covalent bond, with the proviso that if n=0, then X is a covalent bond.

Each R² is independently a C₅-C₅₀ hydrocarbyl group having 1 to 3 rings, optionally collectively bound to one to four (e.g., 1, 2, 3, or 4) C₁-C₄ alkyl groups. Examples of R² include cyclopentyl, phenyl, tolyl (e.g., o-, m-, or p-tolyl), dimethylphenyl, trimethylphenyl, tert-butylphenyl, di-tert-butylphenyl, cyclohexyl, methylcyclohexyl, dimethylcyclohexyl, trimethylcyclohexyl, heptyl, tert-butylcyclohexyl, di-tert-butylcyclohexyl, decalinyl, dimethyldecalinyl, tert-butyldecalinyl, biphenylyl, phenanthryl, naphthyl, anthryl, cumylphenyl, phenethyl, and phenylpropyl. In many embodiments, each R² is independently a C₅-C₃₀ hydrocarbyl group having 1 to 3 rings collectively bound to a total of one or two C₁-C₄ alkyl groups. In some embodiments, each R² is independently a C₆-C₁₆ hydrocarbyl group having 1 to 3 rings collectively bound to a total of one or two C₁-C₄ alkyl groups. In some embodiments, each R² is independently a C₆-C₁₂ hydrocarbyl group having 1 to 3 rings collectively bound to a total of one or two C₁-C₄ alkyl groups.

Exemplary monomer components according to the above formula include 4-(2-naphthyloxy)butyl prop-2-enoate, 11-(4-phenylphenoxy)undecyl prop-2-enoate, 11-[4-(1-methyl-1-phenyl-ethyl)phenoxy]undecyl prop-2-enoate, 11-(4-tert-butylphenoxy)undecyl prop-2-enoate, and 11-[(1R,2S,5R)-2-isopropyl-5-methyl-cyclohexoxy]undecyl prop-2-enoate, 11-(4-methylphenoxy)undecyl prop-2-enoate, 11-(p-tolylsulfanyl)undecyl prop-2-enoate, which can be prepared as described below.

In some embodiments, at least one of the monomers of component (d) is a crystalline monomer having a crystalline melting point of at least 30° C., at least 35° C., at least 40° C., at least 45° C., at least 50° C., at least 55° C., at least 60° C., at least 65° C., or even at least 70° C., and melting point less than 200° C., less than 175° C., less than 150° C., less than 125° C., less than 100° C., or even less than 75° C., taken in any combination. The melting point of the monomers is considered to be the midpoint of the melting range of the monomers. The melting range of crystalline organic solids can be determined according to ASTM E324-16 (2016) “Standard Test Method for Relative Initial and Final Melting Points and the Melting Range of Organic Chemicals”. It is appreciated to those normally skilled in the art that compounds must be of sufficient purity to obtain a narrow range of melting temperatures, such as a range of less than 5° C., 4° C., 3° C., 2° C., and insufficient purity can depress the melting point.

In some embodiments, at least one monomer component is represented by the formula

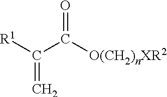

where R¹ is C₁-C₄ alkyl, n is greater than 4, 5, 6, 7, 8, 9, 10, and less than 18, 17, 16, 15, 14, X is O, S, each R² is independently a C₅-C₅₀ hydrocarbyl group optionally having 1 to 3 rings collectively bound to a total of one to four C₁-C₄ alkyl groups. In some embodiments, R² is represented by one of the formulas below:

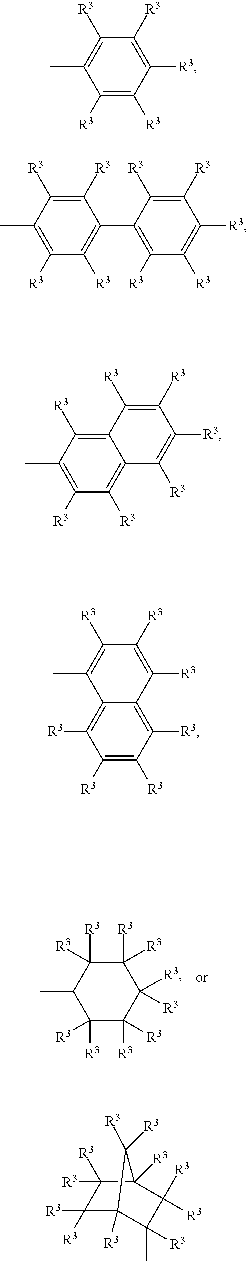

wherein each R³ is independently H or a C₁-C₄ alkyl group, with the proviso that at least one R³ is a C₁-C₄ alkyl group.

In some embodiments, each R² group can be chiral. For example, in some cases, it may be advantageous to utilize one particular stereoisomer of the R² group, rather than a racemic mixture of the R² group stereoisomers. Examples of pure stereoisomers would include, but are not limited to, derivatives of (−) menthol, (+) menthol, (−) isomenthol, (+) isomenthol, (−) neomenthol, (+) neomenthol, (−) isoneomenthol, (+) isoneomenthol, (1R)-endo-(+)-fenchyl alcohol, and (1S)-(−)-borneol.

Copolymers according to the present disclosure can generally be prepared by free-radical copolymerization according to one or more generally known free-radical polymerization techniques (e.g., solution polymerization or emulsion polymerization). Suitable solvents may include water and/or organic solvent. Generally, the monomer components a) through d), and any additional copolymerizable monomers that may be desired (preferably non-fluorinated monomers) are combined in the presence of a free-radical initiator (typically a thermal free-radical initiator) that is decomposed (e.g., by light, heat, or chemical reaction), thereby causing copolymerization of the monomers. Exemplary thermally decomposable free-radical thermal initiators include peroxides (e.g., benzoyl peroxide, chlorobenzoyl peroxide, or methyl ethyl ketone peroxide) and certain azo compounds (e.g., azobisisobutyronitrile (AIBN)), and redox initiators. Exemplary suitable photoinitiators include 1-hydroxycyclohexyl phenyl ketone; 2,2-dimethoxy-1,2-diphenylethan-1-one; bis(2,4,6-trimethylbenzoyl)phenylphosphine oxide; 1[4-(2-hydroxyethoxy)phenyl]-2-hydroxy -2-methyl-1-propane-1-one; 2-benzyl-2-dimethylamino-1-(4-morpholinophenyl)butanone; 2-dimethylamino-2-(4-methyl-benzyl)-1 -(4 -morpholin-4-yl-phenyl)-butan-1-one; 2-methyl-1-[4-(methylthio)phenyl]-2-morpholinopropan-1-one; oligo [2-hydroxy -2-methyl-1-[4-(1-methylvinyl)phenyl]propanone]; 2-hydroxy -2-methyl-1 -phenyl propan-1-one; 2,4,6-trimethylbenzoyldiphenylphosphine oxide; 2,4,6-trimethylbenzoylphenyl phosphinate; benzyl dimethyl ketal; 2-methyl-2-hydroxypropiophenone; benzoin methyl ether; benzoin isopropyl ether; anisoin methyl ether; aromatic sulfonyl chlorides; photoactive oximes; and combinations thereof. Selection of appropriate conditions is within the capabilities of those having ordinary skill in the art.

Copolymers according to the present disclosure can be dispersed and/or dissolved in a liquid vehicle to facilitate application to a substrate. Suitable liquid vehicles may include water, organic solvents (e.g., ethers, esters, alcohols, ketones, chlorinated hydrocarbons, and/or hydrocarbons). In some embodiments (e.g., those involving aerosol dispensers) liquified and/or compressed gases may be combined with the copolymers.

In some cases, the copolymers may be synthesized in organic solvents, and subsequently emulsified into an aqueous dispersion. A dispersion will generally contain water, an amount of composition effective to provide repellent properties to a substrate treated therewith, and a surfactant(s) in an amount effective to stabilize the dispersion. Conventional cationic, nonionic, anionic surfactants or mixtures thereof are suitable. It is also possible to form an aqueous emulsion of the copolymer without conventional surfactants by adding a base (such as triethylamine) and water to the acid functional polymers in solvent, often with heat, then evaporating the organic solvent to leave a dispersed polymer. Copolymers according to the present disclosure can provide a degree of water-repellency and optionally oil-repellency to a substrate (i.e., a solid substrate). FIG. 1 shows an exemplary water repellent article 100 according to the present disclosure, which comprises substrate 110 and non-fluorinated water-repellent treatment 120 disposed on at least a portion thereof.

The substrate may comprise metal, ceramic, glass, concrete, stone, synthetic polymer, and/or natural material, for example In some preferred embodiments, the substrate comprises real leather (e.g., tanned animal skin), synthetic leather, or textile/fabric. Exemplary fabrics include wovens, nonwovens, knits, and braided fabrics. In preferred embodiments, the substrate may comprise at least one of upholstery, awnings, tents, apparel (e.g., clothing, hats, gloves, and coats), fashion accessories, or footwear.

The non-fluorinated water-repellent treatment comprises at least one copolymer according to the present disclosure and may optionally contain one or more additional components such as, for example, antioxidant, ultraviolet (UV) light stabilizer, or optical brightener.

Copolymers according to the present disclosure may comprise monomers having one or more cure sites. By the term “cure site” is meant a functional group that is capable of engaging in a reaction such that it can be bound to a substrate to be treated to impart durability of certain properties. Examples of cure sites include acid groups (such as carboxylic acid groups) and hydroxy groups. In order to improve fixing of the composition to a substrate, it is sometimes advantageous to include in the water and/or oil repellent treatment certain additives, extenders or crosslinkers, polymers, thermo-condensable products and catalysts capable of promoting interaction with the substrate. Among these are the condensates or precondensates of urea or melamine with formaldehyde and glyoxal resins. Other suitable cure enhancers or extenders include blocked isocyanates and polycarbodiimides. Particular suitable additives and amounts thereof can be selected by those skilled in the art.

In many embodiments, the non-fluorinated water- (and optionally oil-) repellent treatment may be applied to the substrate while carried in a liquid vehicle that evaporates after application (e.g., by spraying, dipping, or prolonged soaking). After application of the treatment solution, the substrates may be dried in an oven for up to several minutes at any suitable temperature, often in the range of 100° C. to 200° C. Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted, all parts, percentages, ratios, etc. in the Examples and the rest of the specification are by weight. Table 1, below, reports abbreviations and sources of materials used in the examples.

TABLE 1

| ABBREVIATION | DESCRIPTION | SOURCE |
|---|---|---|
| MCR-M11 | Monomethacryloxypropyl-terminated | Gelest, Morrisville, |
| | polydimethylsiloxane, approx. 800-1000 g/mole | Pennsylvania |
| KF-2012 | Mono-methacry loxypropyl-terminated | Shin-Etsu Chemical |
| | polydimethylsiloxane, approx. 5000 g/mole | Col, Ltd., Tokyo, Japan |
| SIM6487.6 | Methacryloxypropyltris(trimethylsiloxane)silane | Gelest |
| AA | Acrylic acid | Sigma-Aldrich, St. |
| | | Louis, Missouri |
| HPA | Hydroxypropyl acrylate (mixture of 2- | TCI America, Portland, |
| | hydroxypropyl and 2-hydroxy-1-methylethyl | Oregon |
| | acrylate) (stabilized with MEHQ) | |
| ODA | Octadecyl acrylate (Miramer M180), | Miwon Specialty |
| | m.p. = 31-33° C. | Chemicals, Exton, |
| | | Pennsylvania |
| EtOAc | Ethyl acetate | EMD Millipore, |
| | | Burlington, |
| | | Massachusetts |
| BA | Behenyl acrylate | BASF, Ludwigshafen, |
| | | Germany |
| HBA | 4-Hydroxybutyl acrylate | TCI America |
| CD420 | Trimethylcyclohexyl acrylate | Sartomer, Exton, |
| | | Pennsylvania |
| VAZO 67 | 2,2′-Azobis(2-methylbutyronitrile) | Sigma-Aldrich |
| PGME | 1-Methoxy-2-propanol | Sigma-Aldrich |
| SR217 | t-Butylcyclohexyl acrylate | Sartomer |
| | Ethanol | EMD Millipore |
| 1N HCl | 1N Hydrochloric acid | JT Baker (Avantor), |
| | | Radnor, Pennsylvania |
| TEA | Triethylamine | EMD Millipore |
| | Phenothiazine | TCI America |
| BHT | Butylated hydroxytoluene, or 2,6-di- | Alfa Aesar, Ward Hill, |
| | tertbutylphenol | Massachusetts |
| | Methanesulfonyl chloride | Alfa Aesar |
| | Acetic acid | EMD Millipore |
| DMF | Dimethylformamide | EMD Millipore |
| | 2-Naphthol | Alfa Aesar |
| K₂CO₃ | Potassium carbonate | EMD Millipore |
| | Sodium bicarbonate | EMD Millipore |
| | 4-Phenylphenol | Alfa Aesar |
| | 11-Bromo-1-undecanol | Oakwood Chemical, |
| | | Estill, South Carolina |
| KI | Potassium iodide | EMD Millipore |
| NaOH | Sodium hydroxide, 0.1N in Water | JT Baker (Avantor) |
| Silica Gel | Silica gel 60, 230-400 mesh, 40-60 microns | Sigma Aldrich |
| | particle size | |
| | Acryloyl chloride | Sigma Aldrich |
| KOH | Potassium Hydroxide, pellets | Alfa Aesar |
| | Heptane | EMD Millipore |
| | n-Butyl acetate | Alfa Aesar |
| | Hexanes | EMD Millipore |
| | 4-tert-Butylphenol | Alfa Aesar |
| p-thiocresol | 4-methylbenzenethiol | Alfa Aesar |
| p-cresol | 4-methylphenol | Alfa Aesar |
| Triflic anhydride | Trifluoromethanesulfonic anhydride | Oakwood Chemical |
| 2,6-Lutidine | 2,6-dimethylpyridine | Alfa Aesar |
| CH₂Cl₂ | Dichloromethane | EMD Millipore |
| NaH | Sodium hydride, 57%-63% dispersion in oil | Alfa Aesar |
| 4-cumylphenol | 4-2-phenylpropan-2-yl phenol | Alfa Aesar |
| | N,N-diisopropylethylamine | Alfa Aesar |
| Fenchyl alcohol | (1R)-endo-(+)-Fenchyl Alcohol | Alfa Aesar |
| | (−) Menthol | Alfa Aesar |
| MgSO₄ | Magnesium Sulfate, Anhydrous | EMD Millipore |
| | Benzophenone | Alfa Aesar |
| Polyester Fabric | 1411004 Poly Pongee without Optical Brightener, | Testfabrics, Inc., |
| | Approx Wt 73 grams/meter² | West Pittston, PA |
| Polyamide Fabric | 1410002 Filament Nylon 6.6 Semi-Dull Taffeta, | Testfabrics, Inc. |
| | Scoured, Heat Set, Approx. Wt. 59 grams/meter² | |
| Polyester/Cotton Fabric | 1415008 65/35 Bleached Broadcloth (without | Testfabrics, Inc. |
| | optical brightener); Approx. Wt. 104 grams/meter² | |

### Test Methods

### Melting Point Test

Melting points (MP) were determined using a Thomas Hoover capillary melting point apparatus, (Arthur H. Thomas Company, Philadelphia, PA) according to ASTM E324-16, except that the oil bath was not preheated to 15° C. below the expected melting range, since the melting range of some of the compounds was only slightly above room temperature. Benzophenone was used as a melting point standard (m. p.=47-49° C.).

### Spray Rating Test

The spray rating of a treated substrate is a value indicative of the dynamic repellency of the treated substrate to water that impinges on the treated substrate. The repellency was measured by standardized test methods (Test Method 22-1996, published in the 2001 Technical Manual of the American Association of Textile Chemists and Colorists—AATCC), and is expressed in terms of a “spray rating” (SR) of the tested substrate. The spray rating was obtained by spraying 250 milliliters (mL) water on the substrate from a height of 15 centimeters (cm). The wetting pattern is visually rated using a 0 to 100 scale, where 0 means complete wetting and 100 means no wetting at all.

### Water Repellency Test

The static water-repellency of a substrate was measured using a series of water-isopropyl alcohol test liquids and was expressed in terms of the “WR” rating of the treated substrate (AATCC Test Method 193-2012). The WR rating corresponded to the most penetrating test liquid which did not penetrate or wet the substrate surface after 10 seconds exposure. Substrates which were penetrated by or were resistant only to 100% water (0% isopropyl alcohol), the least penetrating liquid, were given a rating of 0. Other ratings were determined according to Table 2, below.

TABLE 2

| AATCC AQUEOUS | COMPOSITION | SURFACE TENSION, |
|---|---|---|
| SOLUTION REPELLENCY | water:isopropanol | 10⁻⁵ N/cm |
| GRADE NUMBER | (vol.:vol.) | at 25° C. |
| 0 | None (fails 98% water) | |
| 1 | 98:2 | 59.0 |
| 2 | 95:5 | 50.0 |
| 3 | 90:10 | 42.0 |
| 4 | 80:20 | 33.0 |
| 5 | 70:30 | 27.5 |
| 6 | 60:40 | 25.4 |
| 7 | 50:50 | 24.5 |
| 8 | 40:60 | 24.0 |

Rating Scale:
A = Passes, clear well-rounded drop
B = Borderline pass, rounding drop with partial darkening
C = Fails, wicking apparent and/or complete wetting
D = Fails, complete wetting

### Alternative Static Water Repellency Test

A solution of 79 vol. % deionized water and 21 vol. % isopropyl alcohol (EMD Millipore Corp., Billerica, Massachusetts) was used as a test solution. The test method of “Static Water Repellency AATCC 193” was used, except a drop of the test solution was applied and the time to failure (seconds) was recorded, and failure in this test was a B rating in the AATCC test.

### Oil-Repellency Test

The oil-repellency of a substrate was measured by the American Association of Textile Chemists and Colorists (AATCC) Standard Test Method No. 118-2013, which test was based on the resistance of a treated substrate to penetration by oils of varying surface tensions. The standard test used in the past with fluorochemicals used a scale from 1 to 8, where samples resistant only to KAYDOL mineral oil (the least penetrating of the traditional test oils) were given a rating of 1 (the rating corresponds to the highest numbered test liquid which will not wet the fabric within a period of 30 seconds). Treated substrates resistant to n-heptane (the most penetrating of the test liquids) were given a rating of 8. Other intermediate values were determined using other standard test liquids.

The AATCC hydrocarbon resistance test No. 118-2013 used with fluorine-containing polymers is too severe to be used with non-fluorinated polymers. Therefore, a new oil-repellency scale using higher surface tension oils was established for the current study. A grade of A to D was assigned based on the degree of wetting observed, as in the AATCC test. The descriptions for A to D are listed below. The drops were observed for 30 seconds, then the degree of wetting was noted. Test liquids with higher surface tensions allowed better differentiation between the efficacy of the different fabric treatments. Table 3, below, reports surface tension of certain test liquids.

TABLE 3

| | SURFACE TENSION, |
|---|---|
| TEST LIQUID | 10⁻⁵ N/cm |
| Soybean Oil | 41.4 |
| Peanut Oil | 34.0 |
| Olive Oil | 32.0 |
| Low 30 Motor Oil | 32.0 |
| KAYDOL Mineral Oil | 31.5 |

Rating Scale:
A = Passes, clear well-rounded drop
B = Borderline pass, rounding drop with partial darkening
C = Fails, wicking apparent and/or complete wetting
D = Fails, complete wetting

### Alternative Oil Repellency Test

The test method of “Oil Repellency AATCC 118” was used, except that a solution of 90% Mineral Oil (from Vi-Jon, Smyrna, Tennessee) and 10% hexadecane (from Alfa Aesar, Ward Hill, Massachusetts) was used as a test solution, and a drop of the test solution was applied and the time to failure (seconds) was recorded. Failure in this test was a B rating in the AATCC 118 test.

### Contact Angle Measurement

Water and hexadecane contact angles of each sample were measured using a Ramé-Hart goniometer (Ramé-Hart Instrument Co., Succasunna, New Jersey). Advancing (θadv) and receding (θrec) angles were measured using deionized water or hexadecane supplied via a syringe needle into or out of sessile droplets, following the method described in Korhonen, et. al (Langmuir, 2013, 29, 3858-3863). Reported measurements are averages of three values for each sample with each measurement itself representing an average of both the left and right side of each drop.

Preparation of PE1 (4-methylsulfonyloxybutyl prop-2-enoate)

PE1 was prepared by adding HBA (200 g, 1.39 mol) to a 2 L, 3-necked round-bottomed flask (RBF) fitted with a magnetic stirrer and a temperature probe. Ethyl acetate (800 g) was then added, followed by triethylamine (200 g, 1.42 mol). Phenothiazine (0.1 g) and BHT (0.08 g) were then added. The flask was then cooled in an ice bath. An addition funnel was added to the flask and methanesulfonyl chloride (200 g, 1.75 mol) was added to the addition funnel. The contents in the flask were about 14° C. when the methanesulfonyl chloride was added slowly dropwise. The temperature was maintained between 15° C. and 25° C. by control of the addition rate of the methanesulfonyl chloride. A precipitate formed. This mixture was stirred for about 3.5 hours. Acetic acid (10 g) and water (319 g) was added and the mixture stirred for 20 minutes. This mixture was then separated using a separatory funnel. The organic phase was washed with 200 mL saturated sodium bicarbonate solution. The organic phase was dried over MgSO₄ and evaporated to give 285 g of PE1 as an orange-colored oil.

Preparation of PE2 (4-(2-naphthyloxy)butyl prop-2-enoate)

4-(2-Naphthyloxy)butyl prop-2-enoate was prepared by mixing PE1 (75.3 g, 339 mmol), 2-napthol (50.0 g, 347 mmol), potassium carbonate (75.3 g, 545 mmol), dimethylformamide (660 g), and BHT (0.12 g) in a 1 L 3-necked RBF fitted with an internal thermometer, and mechanical stirrer. The mixture was heated to 80° C. for 4 hours, during which time a precipitate occurred. The mixture was cooled to room temperature, and then poured into a mixture of 500 mL deionized water and extracted into 5×200 mL portions of heptane. The heptane extract was washed with 200 mL 0.1 N NaOH, and 500 mL water, then dried over MgSO₄, filtered, concentrated, and chromatographed on silica gel (heptane- 10% EtOAc/heptane) to give 55 g of 4-(2-naphthyloxy)butyl prop-2-enoate as a yellow oil that solidified on standing. Phenothiazine (1.5 mg) was added to the product fractions before concentration to avoid polymerization. m .p.=34-37° C.

Preparation of PE3 (11-(4-phenylphenoxy)undecane-1-ol)

PE3 was prepared by charging 4-phenylphenol (40 g, 235 mmol), 11-bromo-1-undecanol (50.4 g, 201 mmol), and KI (5 g, 30 mmol) to a 500 mL 3-necked round-bottomed flask fitted with internal thermometer and magnetic stir bar, and 250 g DMF was added. The mixture was stirred until all solids dissolved to form a slightly yellow solution. K₂CO₃ was then added as a solid and the mixture was stirred for 72 hours at 85° C. The mixture was cooled to RT and poured into 1.5 L of water containing 20 g KOH and the mixture was stirred for 20 minutes. The precipitate was isolated by filtration, then recrystallized from ethanol (˜1200 mL). The recrystallized product was found to have ˜20 mol % of 4-phenylphenol left over. The material was taken up in hot ethanol, and 12 g KOH was added until all materials were fully dissolved. The ethanol was then evaporated completely, and the material was refluxed in ˜1500 mL of 10% n-butyl acetate in heptane for 10 minutes. The mixture was filtered hot, and the filtrate was allowed to cool to room temperature. A crystalline product formed. This was then was cooled to 5° C. overnight and filtered, yielding 40.9 g of PE3 as a white solid.

Preparation of PE4 (11-(4-phenylphenoxy)undecyl prop-2-enoate)

11-(4-phenylphenoxy)undecyl prop-2-enoate was prepared by charging PE3 (40.9 g, 120 mmol) to a 2 L, 3-necked round-bottomed flask fitted with internal thermometer, addition funnel, and magnetic stir bar, and purged with nitrogen. Dichloromethane (1 L) was added, followed by triethylamine (14 g, 139 mmol). Not all of the material was dissolved. Acryloyl chloride (14 g, 155 mmol) was added dropwise via addition funnel, keeping the temperature below 25° C. This was stirred ˜5 min and resulted in a mostly clear solution. Thin layer chromatography (TLC) analysis (20% EtOAc in heptane) showed some residual alcohol starting material, so more acryloyl chloride (2.0 g, 22 mmol) and triethylamine (1.0 g, 10 mmol) was added. TLC analysis was done again and starting material was no longer evident. The reaction mixture was then evaporated to dryness on a rotary evaporator, and then ˜1500 mL heptane was added. This mixture was brought to reflux and stirred 15 minutes. The mixture was then filtered hot, and the filtrate was cooled first to room temperature, then placed in a freezer at ˜−20° C. and a product crystallized. The product was filtered to give 35.6 g of 11-(4-phenylphenoxy)undecyl prop-2-enoate as a crystalline off-white solid, m. p.=61-64° C.

Preparation of PE5 (11-[4-(1-methyl-1-phenyl-ethyl)phenoxy]undecan-1-ol)

NaH (10.5 g, 263 mmol) was added to a 2 L, 3-necked round-bottomed flask, evacuated, and purged with nitrogen. The solid NaH was washed with 200 mL heptane, and the heptane was decanted leaving the sodium hydride in the flask. This was repeated. DMF (600 mL) was then added. 4-Cumylphenol (55.0 g, 259 mmol) was then added in portions under heavy flow of nitrogen, keeping bubbling under control. The material was then heated to 80° C. until bubbling stopped. KI (5 g, 30 mmol) and 11-bromo-1-undecanol (70 g, 278 mmol) was then added, and the mixture was heated to 80° C. The mixture was stirred 12 hours and then heat was removed. After cooling to room temperature, the mixture was poured into a separatory funnel containing 500 mL of 5% aqueous KOH and 500 mL heptane. The mixture was shaken, and the aqueous phase extracted with 500 mL heptane. The combined organic extracts were then washed with 500 mL 5% aqueous KOH solution, followed by 500 mL deionized water, dried over MgSO₄, and 30 g silica gel was added, and the mixture stirred for 5 minutes then filtered. The material was concentrated and purified by silica gel chromatography (gradient heptane to 30% EtOAc in heptane) to give 63.2 g (63.8%) of PE5 a faint yellow oil.

Preparation of PE6 (11-[4-(1-methyl-1-phenyl-ethyl)phenoxy]undecyl prop-2-enoate)

A 2 L, 3-necked round-bottomed flask was fitted with addition funnel, internal thermometer, and magnetic stirrer, and was evacuated and backfilled with nitrogen. PE5 (11-[4-(1-methyl-1-phenyl-ethyl)phenoxy]undecan-1-ol) (61.8 g, 162 mmol) and 1000 mL dichloromethane was added, followed by acryloyl chloride (18.2 g, 201 mmol) and the solution stirred and cooled to ˜5° C. in an ice bath. N,N-diisopropylethylamine (22.0 g, 170 mmol) was added dropwise, keeping the temperature below 10° C. After the addition was complete, the mixture was warmed to room temperature and stirred overnight. TLC (20% EtOAc in heptane) indicated complete consumption of the alcohol. 500 mL of 5% aqueous KOH was added, and the mixture stirred 30 minutes. This was then shaken and separated in a separatory funnel, and the aqueous phase was extracted with 200 mL dichloromethane. The combined organic extracts were then washed with 500 mL of a solution of 1 M aqueous HC1, followed by 500 mL of deionized water. The organic phase was dried over MgSO₄, evaporated, taken up in 1000 mL 20% dichloromethane in heptane, and filtered over a short plug of silica gel, and concentrated by rotary evaporation to give 63.5 of 11-[4-(1-methyl-1-phenyl-ethyl)phenoxy]undecyl prop-2-enoate as a slightly yellow oil.

Preparation of PE7 [(1R,2S,4S)-1,3,3-trimethylbicyclo[2.2.1]heptan-2-yl acrylate]

(1R)-endo-(+) fenchyl alcohol (15.42 g, 100 mmol) was added to a nitrogen-purged 500 mL three-necked round-bottomed flask. Dichloromethane (175 mL) was added to the flask, which was continuously mixed with a magnetic stir bar. The flask was equipped with a temperature probe, nitrogen inlet at 1 L/minute and 60 mL addition funnel. Triethylamine (14.17 g, 140 mmol) was added to the flask as well. The mixture was cooled to 5° C. by placing an ice bath under the flask. Acryloyl chloride (13.58 g, 150 mmol) was carefully transferred to the addition funnel, and the acryloyl chloride was added dropwise to the flask, keeping the temperature below 10° C. The mixture was stirred overnight and allowed to warm to room temperature. When stirring was stopped, a clear orange bottom layer with white/yellow top layer of salts was observed. The solution was transferred to a one-necked 500 mL round-bottomed flask, rinsing in with hexanes to complete the transfer. The dichloromethane/hexanes were removed on the rotary evaporator. Hexanes (170 g) was added to dissolve for washing, and the mixture was transferred to a separatory funnel. The solution was washed with water to extract salts, and the water phase was saved. The hexanes solution was dried with magnesium sulfate, filtered twice, and transferred to a 250 mL round-bottomed flask to remove hexanes on the rotary evaporator. After the solvent was stripped off, there was little monomer remaining. It was not present in the collected solvent on the rotary evaporator, so the salt phase was dissolved in ethyl acetate ˜(200 mL) and water (200 mL), placed in a separatory funnel, shaken, and the aqueous phase extracted with 200 mL EtOAc. The combined organic extracts were then washed with 200 mL 1 M HCl, followed by 200 mL deionized water, then dried over magnesium sulfate and filtered. The ethyl acetate was removed on a rotary evaporator. The resulting oil was distilled (b. p.=25-30° C., 100 mtorr) to yield 15 grams of a clear liquid.

Preparation of PE8 (11-(2-naphthyloxy)undecan-1-ol)

NaH (12.7 g, 333 mmol) was added to a 2 L, 3 neck RBF, evacuated, and purged with nitrogen. The solid NaH was washed with 200 mL heptane, and the heptane decanted. This was repeated. DMF (600 mL) was then added. 2-napthol (48.0 g, 333 mmol) was then added in portions under heavy flow of nitrogen, keeping bubbling under control. The material was then heated to 80° C. until bubbling stopped. KI (5 g, 30 mmol) and 11-bromo-1-undecanol (75 g, 299 mmol) was then added, and the mixture was heated to 80° C. The mixture was stirred 12 hours at 80° C. then heat was removed. The mixture was poured into 500 mL 5% KOH in water and 750 mL ethyl acetate in a separatory funnel, shaken, and the aqueous layer extracted 2×200 mL EtOAc. 250 mL heptane was added to the organic extracts. The combined organic extracts were then washed with 500 mL 5% KOH solution twice, followed by 500 mL deionized water. The organic phase was then dried over MgSO₄, 30 g silica gel was added, and the mixture was stirred 10 minutes and filtered. The filtrate was concentrated by rotary evaporation to yield a solid which was recrystallized from ethanol to give 79.15 g of a white crystalline solid.

Preparation of PE9 (11-(2-naphthyloxy)undecyl prop-2-enoate)

PE8 (11-(2-naphthyloxy)undecan-1-ol) (79.0 g, 251 mmol) was charged into a 2 L 3 necked round bottomed flask fitted with internal thermometer and an addition funnel, and then dichloromethane (1 L) was added. The flask was then blanketed with nitrogen and cooled to ˜5° C. in an ice bath. Acryloyl chloride (28.5 g, 315 mmol) was added directly into the flask. The resulting suspension was stirred and N,N-diisopropylethylamine (36.75 g, 284 mmol) was added into the closed addition funnel, keeping the temperature below 10° C. The mixture turned clear after addition of the amine. This was stirred overnight at RT. 500 mL of 5% aqueous KOH was then added to the flask and it was stirred for 1 hour. The mixture was separated, and aqueous phase extracted with 100 mL dichloromethane. The combined organic extracts were then washed with 500 mL 10% conc. HCl in water, followed by 500 mL deionized water, dried over MgSO₄, filtered, and evaporated. The resulting oil was taken up in 800 mL 10% dichloromethane in heptane and filtered over a plug of silica gel, and the solvent was removed by rotary evaporation to give 84.37 g (91.1%) of PE9 as a colorless oil that solidified on standing, m. p.=38-39° C.

Preparation of PE10 (11-(4-tert-butylphenoxy)undecan-1-ol)

A 2 L 3-necked round-bottomed flask was fitted with internal thermometer and magnetic stir bar, evacuated and backfilled with nitrogen. NaH (17.5 g, 438 mmol) was added under nitrogen, and 200 mL heptane was added and stirred 5 minutes. This was decanted to remove the mineral oil, leaving the sodium hydride in the flask. Dimethylformamide (800 mL) was then added. 4-Tertbutylphenol (75.0 g, 499 mmol) was added slowly under strong stirring and ˜1 liter per minute flow of nitrogen. This was stirred for 1 hour when bubbling stopped. KI (5 g, 40 mmol) and 11-bromo-1-undecanol (100 g, 398 mmol) were added, and the mixture was heated to 70° C. for 1 hour and then the temperature was raised to 80° C. and stirred overnight. The mixture was then cooled to 40° C., then poured into 400 mL of 2.5% aqueous KOH and 400 mL of heptane in a separatory funnel. The mixture was shaken and separated, and the aqueous phase was extracted with 400 mL heptane. The combined organic extracts were then washed with 400 mL of 3% aqueous KOH, followed by 400 mL deionized water. The organic phase was then dried over anhydrous MgSO₄, and then 45 g silica gel was added, and the mixture stirred for 10 minutes. The mixture was then filtered, and the solvent removed by rotary evaporation to give 104.91 g of PE10 as a slightly yellow oil that solidified upon standing.

### Example 1

Preparation of 11-(4-tert-butylphenoxy)undecyl prop-2-enoate

A 2 L 3-necked round-bottomed flask was fitted with internal thermometer, addition funnel, and magnetic stir bar, and was evacuated and backfilled with nitrogen 3×. PE10 (11-(4-tert-butylphenoxy)undecan-1-ol) (93.6 g, 292 mmol), dichloromethane (900 mL), and triethylamine (60.0 g, 592 mmol), were then charged to the flask, which was cooled to ˜5° C. in an ice bath. Acryloyl chloride (28 g, 309 mmol) was then added dropwise, keeping the temperature below 10° C. This was stirred 15 minutes, and TLC was performed (25% EtOAc in heptane) and it was found that some alcohol starting material remained. An additional portion of acryloyl chloride (4.0 g, 44 mmol) was added dropwise, and stirred an additional 30 minutes. TLC showed complete consumption of the starting alcohol. The mixture was then warmed to room temperature, stirred for 1 hour, and an additional charge of triethylamine (30.0 g, 296 mmol) was added. This was stirred 2 more hours, and then the mixture was concentrated by rotary evaporation. The material was taken up in 2000 mL of heptane, filtered, and further filtered through a plug of silica gel. The silica gel was washed with 5% EtOAc in heptane. The solution was then concentrated to about 1300 mL, and washed with 300 mL 10% NaCl containing 10 mL of concentrated HCl. The aqueous phase was then extracted with 200 mL heptane. The combined organic phase was dried over MgSO₄, and 30 g silica gel was added. The mixture was stirred 10 minutes and then filtered and concentrated to give 97.3 g of 11-(4-tert-butylphenoxy)undecyl prop-2-enoate as an orange oil which solidified on standing.

Preparation of PE11 (11-bromo-1-undecyl trifluoromethanesulfonate)

Dichloromethane (1500 mL) and triflic anhydride (229 g, 812 mmol) were charged to a 3 L 3-necked round-bottomed flask with internal thermometer, magnetic stirrer, and addition funnel under nitrogen. This mixture was cooled to ˜5° C. in an ice bath. Care was taken to keep the mixture dry. 11-Bromo-1-undecanol (200 g, 796 mmol) was dissolved in 268 g dichloromethane and 2,6-lutidine (88 g, 821 mmol). This mixture was added dropwise to the triflic anhydride solution, keeping the temperature below 10° C. After the addition, the solution was warmed to room temperature and stirred overnight. The mixture was then concentrated by rotary evaporation and taken up in 1700 mL heptane. A precipitate occurred. The mixture was then filtered, and the filtrate was concentrated by rotary evaporation to give 278 g of PE11 as a red oil.

Preparation of PE12 ((1S,2R,4R)-2-(11-bromoundecoxy)-1-isopropyl-4-methyl-cyclohexane)

A 500 mL, 3-necked round-bottomed flask was charged with (−) menthol (32.75 g, 209 mmol) and dichloromethane (200 mL), and then PE11 (11-bromo-1-undecyl trifluoromethanesulfonate) (40.0 g, 104 mmol) and 2,6-lutidine (12.2 g, 105 mmol) were added and the reaction mixture was stirred for 72 hours at room temperature. The mixture was then evaporated by rotary evaporation, and then 200 g heptane and 50 g dichloromethane were added. This was then filtered through a plug of silica gel, concentrated, and then purified via silica gel chromatography (10% dichloromethane in heptane) to give 22.6 g of PE12 as a colorless oil.

### Example 2

Preparation of 11-[(1R,2S,5R)-2-isopropyl-5-methyl-cyclohexoxy]undecyl prop-2-enoate

A 500 mL 3-necked round-bottomed flask fitted with an internal thermometer and magnetic stirrer was charged with K₂CO₃ (25.0 g, 181 mmol), KI (5.0 g, 30 mmol) and 200 mL DMF. Acrylic acid (15.0 g, 208 mmol) was then added slowly. Some bubbling occurred. PE12 ((1S,2R,4R)-2-(11-bromoundecoxy)-1-isopropyl-4-methyl-cyclohexane) (22.6 g, 58.0 mmol) was added, and the mixture heated to 90° C. overnight. The mixture was then cooled to room temp and poured into a mixture of 500 mL 5% aqueous KOH and 500 mL heptane. The aqueous phase was then extracted with 500 mL heptane, and the organic phase washed with 500 mL deionized water twice. The combined organic extracts were dried over MgSo₄, filtered over a short plug of silica gel, and concentrated to give 16.57 g of 11-[(1R,2S,5R)-2-isopropyl-5-methyl-cyclohexoxy]undecyl prop-2-enoate as a colorless oil.

Preparation of PE13 (11-(4-methylphenoxy)undecan-1-ol)

NaH (14.0 g, 350 mmol) was charged in a 2 L, 3-necked RBF fitted with internal thermometer and magnetic stirrer, and the flask was evacuated and backfilled with nitrogen twice. Under heavy flow of nitrogen, the solid NaH was washed with 200 mL heptane, and the heptane decanted. This was repeated. DMF (800 mL) was then added. p-cresol (40.0 g, 370 mmol) was then added in portions under heavy flow of nitrogen, keeping bubbling under control. The material was then heated to 70° C. until bubbling stopped. KI (5 g, 30 mmol) and 11-bromo-1-undecanol (75 g, 299 mmol) was then added, and the mixture was heated to 80° C. for 16 hours. The solution was cooled to room temperature. This was poured into a mixture of 500 mL of water with 8% aqueous KOH and 500 mL of 30% EtOAc in heptane in a separatory funnel. The mixture was shaken, separated, and the aqueous phase was again extracted with 500 mL 30% EtOAc in heptane. The combined organic extracts were then washed with 500 mL of 4% aqueous KOH, and then 500 mL DI water. The organic fraction was then dried over MgSO₄, and 55 g silica gel was added and the mixture stirred overnight. The mixture was then filtered and concentrated by rotary evaporation to give 74.0 g (89.0%) of an off-white solid.

### Example 3

Synthesis of 11-(4-methylphenoxy)undecyl prop-2-enoate

PE13 (11-(4-methylphenoxy)undecan-1-ol) (62.3 g, 224 mmol) was charged into a 2 L, 3 neck RBF fitted with thermometer, magnetic stir bar, and addition funnel, and then evacuated and backfilled with nitrogen. Dichloromethane (800 mL) and acryloyl chloride (22.3 g, 280 mmol) were then added, and the mixture cooled to ˜5° C. N,N-diisopropylethylamine (30.5 g, 236 mmol) was added to the addition funnel, and was added dropwise keeping the temperature of the reaction mixture under 10° C. After the addition, the mixture was warmed to room temperature and stirred 1 h. TLC (30% EtOAc in heptane) indicated complete consumption of the starting material alcohol. The mixture was then washed with 500 mL 5% aqueous KOH. This was extracted 2×100 mL dichloromethane. The combined organic extracts were then washed with 500 mL of a 5% conc. HCl/water solution, and then 500 mL deionized water. The extracts were dried over MgSO₄, and diluted with 1000 mL heptane. 30 g silica gel was added and this was stirred for 10 minutes, and then filtered, and evaporated to give 70.5 g (94.7%) of a faintly orange liquid. The product was recrystallized from heptane to give 62.2 g (83.6%) of a white crystalline solid, m. p.=40-41.5° C.

Synthesis of PE14 (11-(p-tolylsulfanyl)undecan-1-ol)

NaH (9.0 g, 225 mmol) was charged in a 2 L, 3 neck RBF fitted with internal thermometer and magnetic stirrer, and the flask was evacuated and backfilled with nitrogen twice. Under heavy flow of nitrogen, the solid NaH was washed with 200 mL heptane, and the heptane decanted. This was repeated. DMF (500 mL) was then added. p-Thiocresol (30.5 g, 246 mmol) was then added in portions under heavy flow of nitrogen, keeping bubbling under control. The material was then heated to 70° C. until bubbling stopped. KI (5 g, 30 mmol) and 11-bromo-1-undecanol (50.0 g, 199 mmol) was then added, and the mixture was heated to 80° C. for 16 hours. The solution was cooled to room temperature. This was poured into a mixture 5% aqueous KOH and 500 mL of 30% EtOAc in heptane in a separatory funnel. The mixture was shaken, separated, and the aqueous phase was again extracted with 500 mL 30% EtOAc in heptane. The combined organic extracts were then washed with 500 mL of 5% aqueous KOH, and then 500 mL DI water. The organic fraction was then dried over MgSO₄, and filtered over a short plug of silica gel. This was concentrated by rotary evaporation to give 53.6 g (91.5%) of a white solid.

### Example 4

Synthesis of 11-(p-tolylsulfanyl)undecyl prop-2-enoate

PE14 (11-(p-tolylsulfanyl)undecan-1-ol) (53.0 g, 180 mmol) was charged in a 1 L, 3 necked RBF fitted with internal thermometer, addition funnel, magnetic stirrer, and nitrogen inlet. Nitrogen was blanketed over the material. Dichloromethane (650 mL) was then added, and the alcohol was allowed to dissolve. Acryloyl chloride (20.4 g, 225 mmol) was then added to the solution, which was then cooled to ˜4° C. in an ice bath. N,N-diisopropylethylamine (25.5 g, 197 ,mmol) was then added dropwise to the mixture, keeping the temperature below 10° C. The material was stirred 15 minutes and then allowed to warm to room temperature. TLC analysis (20% EtOAc in heptane) was performed and this showed some starting material remaining Additional N,N-diisopropylethylamine (4 g, 21 mmol) and acryloyl chloride (2 g, 22 mmol) were added, and the mixture was allowed to stir overnight at room temperature. TLC analysis indicated the disappearance of the starting material. The mixture was then poured into 500 mL of 5% aqueous KOH, and shaken in a separatory funnel. The aqueous fraction was extracted with 200 mL dichloromethane, and then the combined organic fractions were washed with 500 mL 1 M HCl, followed by 500 mL deionized water. The organic fraction was then diluted by 800 mL heptane, dried over MgSO₄, and filtered over a short plug of silica gel. The solvent was then evaporated by rotary evaporation, and the resulting solid was recrystallized from heptane to give 47.9 g (76.4%) of a white crystalline solid, m. p.=30-31° C.

Synthesis of PE15 [(1S,2R,5S)-2-isopropyl-5-methyl-cyclohexyl] prop-2-enoate]

(−) Menthol (23.44 grams, 150 mmol) was added to a nitrogen-purged 1 L three-necked flask equipped with a temperature probe and 60 mL addition funnel. Dichloromethane (783 mL) was added to the flask as well. The solution was continuously mixed with a stir bar. Triethylamine (21.25 grams, 210 mmol) was added to the flask as well. An ice bath was placed under the flask. Acryloyl chloride (20.36 grams, 225 mmol) was carefully transferred to the addition funnel. As soon as the temperature dropped to around 5° C., the acryloyl chloride was added dropwise into the solution in the flask. The mixture turned yellow but remained mostly clear/no salt observed. Addition continued in aliquots over about an hour, with no real exotherm observed. The clear bright yellow solution was allowed to warm to room temperature overnight. The dichloromethane was removed on a rotary evaporator. Heptane (650 grams) was added to the remaining orange slurry, dissolving the product but not the salt. The solution portion was run through silica in a fritted funnel, leaving the salt in flask. A clear colorless liquid was obtained, which was stripped on the rotary evaporator to remove the heptane, leaving a clear liquid product.

### Examples 5-36 and Comparative Examples A-F

Copolymer samples were prepared as follows. The monomers, initiator and solvent were charged to a (4 oz, 120 mL) Boston round glass heavy weight bottle in amounts reported in the tables below. The monomers were charged at 28.6 weight percent solids in ethyl acetate. VAZO 67 initiator was charged at 0.69 weight percent of the total solids composition. The bottle was purged with nitrogen gas, then sealed with a polytetrafluoroethylene-lined metal cap. The cap was wrapped with electrical tape to secure it before placing the bottle in a safety cage with lid, using sponges to fill unoccupied space in the cage. Finally, the cage was secured with retaining bars in a water-filled launderometer tank at 65° C. After approximately 22 hours, the bottle was removed from the launderometer. The resultant polymers were slightly viscous clear polymer solutions (˜28% solids). Tables 4, 5 and 6, below, report Example copolymer compositions.

TABLE 4

| | WEIGHT PERCENT | | | | | | |
|---|---|---|---|---|---|---|---|
| | | | | | | | CYCLIC |
| EXAMPLE | MCR-M11 | KF-2012 | HPA | AA | ODA | BA | MONOMER A |
| 5 | | 16.6 | 46.4 | 3.3 | | 33.1 | |
| 6 | 6.6 | 6.6 | 59.5 | 5 | | 21.5 | |
| 7 | 6.6 | 6.6 | 16.6 | 6.6 | 62.8 | | |
| 8 | 9.9 | 16.5 | 23.2 | 6.6 | 32.7 | | 10.4 wt. % CD420 |
| 9 | 9.9 | 16.5 | 23.2 | 6.6 | 32.7 | | 10.4 wt. % PE2 |
| 10 | 10.4 | 7 | 17.4 | 6.3 | 38.8 | | 19.5 wt. % SR217 |
| 11 | 17.4 | 7 | 17.4 | 6.3 | 34.3 | | 17.1 wt. % SR217 |
| 12 | 13.9 | 7 | 17.4 | 6.3 | 36.5 | | 18.3 wt. % SR217 |
| 13 | 15.8 | 7.9 | 19.7 | 7.1 | 37.1 | | 11.8 wt. % CD420 |
| 14 | 13.9 | 6.9 | 17.4 | 6.3 | 33.3 | | 21.5 wt. % PE4 |

TABLE 5

| | WEIGHT PERCENT | | | | | CYCLIC | CYCLIC | CYCLIC |
|---|---|---|---|---|---|---|---|---|
| EXAMPLE | MCR-M11 | KF-2012 | HPA | AA | ODA | MONOMER A | MONOMER B | MONOMER C |
| 15 | 13.9 | 7 | 17.4 | 6.3 | 33.4 | 12.5 wt. % SR217 | 8.9 wt. % PE4 | |
| 16 | 13.9 | 7 | 17.4 | 6.3 | 36.7 | 18.1 wt. % EX1 | | |
| 17 | 13.9 | 7 | 17.4 | 6.3 | 33.3 | 21.5 wt. % EX1 | | |
| 18 | 13.9 | 7 | 17.4 | 6.3 | 33.3 | 5.6 wt. % SR217 | 16 wt. % EX1 | |
| 19 | 13.9 | 7 | 17.4 | 6.3 | 36.7 | 18.1 wt. % EX2 | | |
| 20 | 13.9 | 7 | 17.4 | 6.3 | 36.7 | 18.1 wt. % PE6 | | |
| 21 | 13.9 | 7 | 17.4 | 6.3 | 27 | 7 wt. % SR217 | 10.4 wt. % PE4 | 10.4 wt. % EX1 |
| 22 | 13.9 | 6.9 | 17.4 | 6.3 | 20.1 | 6.9 wt. % SR217 | 10.4 wt. % PE4 | 17.4 wt. % EX1 |

TABLE 6

| | WEIGHT PERCENT | | | | | CYCLIC | CYCLIC | CYCLIC |
|---|---|---|---|---|---|---|---|---|
| EXAMPLE | MCR-M11 | KF-2012 | HPA | AA | ODA | MONOMER A | MONOMER B | MONOMER C |
| 23 | 14 | 7 | 14 | 8.3 | 38.1 | 18 wt. % PE7 | | |
| 24 | 13.9 | 6.9 | 17.4 | 6.3 | 27.1 | 7 wt. % SR217 | 10.4 wt. % PE4 | 10.4 wt. % EX1 |
| 25 | 13.9 | 6.9 | 13.9 | 8.3 | 28.5 | 7 wt. % SR217 | 10.4 wt. % PE4 | 10.4 wt. % EX1 |
| 26 | 14 | 7 | 17.3 | 7 | 31.9 | 11.1 wt. % PE6 | 11.1 wt. % PE9 | |
| 27 | 13 | 6.4 | 17.4 | 7 | 32.8 | 11.4 wt. % PE6 | 11.4 wt. % PE9 | |
| 28 | 14 | 7 | 17.3 | 7 | 29.1 | 25 wt. % EX3 | | |
| 29 | 14 | 7 | 17.3 | 7 | 29.1 | 25 wt. % EX4 | | |
| 30 | 14 | 7 | 17.3 | 6.3 | 33.3 | 21.5 wt. % EX2 | | |
| 31 | 14 | 7 | 17.3 | 6.3 | 33.3 | 21.5 wt. % PE15 | | |
| 32 | 10.4 | 5.2 | 17.4 | 6.9 | 35.1 | 12.1 wt % PE6 | 12.1 wt. % PE9 | |
| 33 | 12.7 | 6.4 | 17.4 | 6.9 | 33 | 11.4 PE6 | 11.4 wt. % PE9 | |
| 34 | 11.3 | 5.6 | 18.9 | 0 | 37.4 | 13 PE6 | 13 wt. % P9 | |
| 35 | 13.7 | 6.8 | 17.2 | 6.8 | 27.4 | 27.4 EX4 | | |
| 36 | 9.1 | 4.6 | 17.2 | 6.8 | 34.3 | 6.8 SIM6487.6 | 10.2 wt. % PE9 | 10.2 wt. % EX1 |

### Testing on Fabric

The 28.6 percent solids copolymer solutions were diluted to about 1.5% solids with 1-methoxy-2-propanol. Treatment of the fabrics was done using a 3 M ACCUSPRAY gun (3M Company, Maplewood, Minnesota), applying a sufficient amount onto each fabric piece to achieve about 1.5% solids on fabric (SOF). The fabric was then heated in an oven. Examples 5 through 14 were heated at 125° C. for 15 minutes. Examples 15 through 29 were heated at 135° C. for 15 minutes. Other cure times/temperatures may also be used. Several different test fabrics, obtained from Testfabrics, Inc., were treated, including polyester, polyamide and a 65/35 polyester/cotton blend. Water and oil repellencies were measured on the treated fabrics. Tables 7, 8, and 9, below, report results of Water- and Oil-Repellency Testing of treated fabrics (1.5% Solids on Fabric).

TABLE 7

| | | | | | | 10W-30 | |
|---|---|---|---|---|---|---|---|
| COPOLYMER | FABRIC, | | | SOYBEAN | PEANUT | MOTOR | MINERAL |
| EXAMPLE | 1.5 wt. % SOF | WR | SR | OIL | OIL | OIL | OIL |
| Comparative | Polyester | 1 | 0 | D | | | |
| Example A, | | | | | | | |
| untreated | | | | | | | |
| Comparative | Polyamide | 0 | 0 | D | | | |
| Example B, | | | | | | | |
| untreated | | | | | | | |
| Comparative | Polyester/Cotton | 0 | 0 | D | | | |
| Example C, | | | | | | | |
| untreated | | | | | | | |
| 5 | Polyester | | 60 | D | | | |
| 5 | Polyamide | | 70 | D | | | |
| 5 | Polyester/Cotton | | 75 | D | | | |
| 6 | Polyester | 3 | 70 | D | | | |
| 6 | Polyamide | 4 | 70 | D | | | |
| 6 | Polyester/Cotton | 3 | 80 | D | | | |
| 7 | Polyester/Cotton | 4 | 80 | B/C | B | D | D |
| 8 | Polyester | 3 | 70 | D | D | | |
| 8 | Polyamide | 4 | 50 | D | D | | |
| 8 | Polyester/Cotton | 4 | 60 | D | D | | |
| 9 | Polyester | 4 | 70 | D | D | | |
| 9 | Polyamide | 3 | 60 | C | D | | |
| 9 | Polyester/Cotton | 4 | 70 | C/D | D | | |
| 10 | Polyester | 3 | 80 | C | | | |
| 10 | Polyamide | 4 | 60 | A/B | A/B | C | |
| 10 | Polyester/Cotton | 4 | 80 | B | B | C/D | |
| 11 | Polyester | 4 | 70 | C | | | |
| 11 | Polyamide | 4 | 50 | A/B | A/B | B | |
| 11 | Polyester/Cotton | 4 | 75 | C/D | | | |
| 12 | Polyester | 3 | 70 | C/D | | | |
| 12 | Polyamide | 4 | 50 | B | B | C | |
| 12 | Polyester/Cotton | 4 | 75 | D | | | |
| 13 | Polyester | 3 | 70 | D | | | |
| 13 | Polyamide | 3 | 50 | C | | | |
| 13 | Polyester/Cotton | 3 | 70 | D | | | |
| 14 | Polyester | 3 | 75 | D | | | |
| 14 | Polyamide | 3 | 70 | C/D | | | |
| 14 | Polyester/Cotton | 3 | 80 | D | | | |

Table 8, below, reports results of Water- and Oil-Repellency Testing of treated fabrics (1.5% Solids on Fabric).

TABLE 8

| | | | | | | | 10W-30 |
|---|---|---|---|---|---|---|---|
| | FABRIC, | | | SOYBEAN | PEANUT | OLIVE | MOTOR |
| EXAMPLE | 1.5% SOF | WR | SR | OIL | OIL | OIL | OIL |
| Comparative | Polyester | 1 | 0 | D | | | |
| Example A, | | | | | | | |
| untreated | | | | | | | |
| Comparative | Polyamide | 0 | 0 | D | | | |
| Example B, | | | | | | | |
| untreated | | | | | | | |
| Comparative | Polyester/Cotton | 0 | 0 | D | | | |
| Example C, | | | | | | | |
| untreated | | | | | | | |
| 15 | Polyester | 3 | 50 | C | C | C | C/D |
| 15 | Polyamide | 3 | 60 | B | B/C | B | C |
| 15 | Polyester/Cotton | 3 | 60 | C/D | B/C | B/C | C/D |
| 16 | Polyester | 3 | 25 | D | C/D | C/D | D |
| 16 | Polyamide | 3 | 60 | B/C | B | B/C | B/C |
| 16 | Polyester/Cotton | 3 | 60 | C | B/C | D | C/D |
| 17 | Polyester | 3 | 60 | C | B/C | C/D | C/D |
| 17 | Polyamide | 3 | 60 | B | B | B | B/C |
| 17 | Polyester/Cotton | 4 | 50 | B/C | B | B | C/D |
| 18 | Polyester | 3 | 60 | C | B/C | B/C | C/D |
| 18 | Polyamide | 3 | 60 | B/C | B | B/C | B/C |
| 18 | Polyester/Cotton | 4 | 70 | A/B | A/B | A/B | C |
| 19 | Polyester | 3 | 70 | C | C | C | D |
| 19 | Polyamide | 4 | 60 | B/C | B/C | C | D |
| 19 | Polyester/Cotton | 4 | 80 | A | A | B | C/D |
| 20 | Polyester | 3 | 70 | C/D | C/D | C/D | C/D |
| 20 | Polyamide | 3 | 60 | B/C | B/C | B/C | C |
| 20 | Polyester/Cotton | 3 | 60 | B/C | B/C | B/C | C/D |
| 21 | Polyester | 4 | 70 | C | C | C/D | D |
| 21 | Polyamide | 4 | 70 | B | B/C | B/C | C |
| 21 | Polyester/Cotton | 4 | 80 | A | A/B | B/C | C/D |
| 22 | Polyester | 3 | 60 | B/C | B/C | B/C | C/D |
| 22 | Polyamide | 3 | 70 | B/C | B/C | B/C | C |
| 22 | Polyester/Cotton | 4 | 60 | B | B | B/C | C |

TABLE 9

| | FABRIC | | | | | | 10W-30 |
|---|---|---|---|---|---|---|---|
| | TREATED AT | | | SOYBEAN | PEANUT | OLIVE | MOTOR |
| EXAMPLE | 1.5% SOF | WR | SR | OIL | OIL | OIL | OIL |
| Comparative | Polyester | 1 | 0 | D | | | |
| Example A, | | | | | | | |
| untreated | | | | | | | |
| Comparative | Polyamide | 0 | 0 | D | | | |
| Example B, | | | | | | | |
| untreated | | | | | | | |
| Comparative | Polyester/Cotton | 0 | 0 | D | | | |
| Example C, | 65/35 | | | | | | |
| untreated | | | | | | | |
| 23 | Polyester | 4 | 50 | B/C | A/B | B/C | C/D |
| 23 | Polyamide | 3 | 40 | B/C | B | B/C | C |
| 23 | Polyester/Cotton | 3 | 50 | C/D | A/B | B/C | C/D |
| 24 | Polyester | 3 | 50 | C | B | B/C | C/D |
| 24 | Polyamide | 3 | 50 | B/C | B/C | B/C | C |
| 24 | Polyester/Cotton | 4 | 60 | B/C | A/B | B/C | C/D |
| 25 | Polyester | 4 | 50 | B/C | B/C | B/C | C/D |
| 25 | Polyamide | 3 | 50 | B/C | B | B/C | C/D |
| 25 | Polyester/Cotton | 4 | 50 | B/C | B | B/C | D |
| 26 | Polyester | 4 | 50 | B/C | B/C | B/C | C/D |
| 26 | Polyamide | 3 | 50 | B/C | B | B/C | C |
| 26 | Polyester/Cotton | 4 | 60 | B/C | B/C | B/C | C/D |
| 27 | Polyester | 4 | 50 | B/C | B/C | B/C | D |
| 27 | Polyamide | 3 | 50 | B/C | B/C | B/C | C |
| 27 | Polyester/Cotton | 4 | 50 | B | B | B/C | C/D |
| 28 | Polyester | 4 | 60 | C | B/C | C | C/D |
| 28 | Polyamide | 3 | 50 | B/C | B/C | B/C | C/D |
| 28 | Polyester/Cotton | 4 | 50 | B/C | B/C | C | C/D |
| 29 | Polyester | 4 | 50 | B/C | B/C | C | D |
| 29 | Polyamide | 3 | 50 | B/C | B | B/C | C |
| 29 | Polyester/Cotton | 4 | 50 | B/C | B | B/C | C/D |

The following examples were treated by a different method. A 4 cm×4 cm of Polyester/Cotton fabric was used (7409WOB, 65/35 Bleached Broadcloth (without optical brightener), approx. 104 g/m²; from Testfabrics inc 1415008). A 2% solution of the polymers was made by diluting the 28.6% solids polymers in EtOAc with PGME, and then 0.5 ml of this solution (sufficient to apply 2% SOF after drying) was applied to the fabric held horizontally on a drying rack. The sample was then held vertically for 10 seconds to drain off any excess solution and then returned to the drying rack. The samples were thoroughly dried at room temperature (RT) and then placed in a 135° C. oven for 30 min. After cooling (and equilibrating with room conditions) they were tested using the above alternative water and oil repellency test methods, which measure time until the test liquid wets the fabric. Results are shown in Table 10 comparing time to wet for Comparative C (untreated polyester/cotton) and for examples 30 through 35.

TABLE 10

| | TIME TO WET | TIME TO WET |
|---|---|---|
| | 79/21 WATER/IPA, | 90/10 MO/HD, |
| EXAMPLE | (seconds) | (seconds) |
| Comparative | 0 | 0 |
| Example C, | | |
| Untreated | | |
| Polyester/Cotton | | |
| 30 | 55 | 17 |
| 31 | 15 | 4 |
| 32 | 60 | 6 |
| 33 | 70 | 6 |
| 34 | 10 | 9 |
| 35 | 10 | 9 |

The copolymers can also be used to treat leather or suede to impart water and oil repellency. The examples in Table 11 show results for treated leather and suede. The substrates were prepared by diluting the 28.6% solids copolymer in EtOAc (Example 21 in Table 5) with additional EtOAc to obtain a 1.5% solids solution. The untreated leather and/or suede were then coated using a pipette to transfer a sufficient amount of 1.5% solids copolymer solution onto the leather or suede, allowing it to absorb into the samples, such that 1.5% SOF would remain after drying. The substrates were dried as noted in Table 11. The repellency was tested with the specified test liquids and noted as time for the test liquid(s) to wet the substrate (i.e. darkening of the substrate) .

TABLE 11

| | TIME TO WET | TIME TO WET | TIME TO WET |
|---|---|---|---|
| | 85/15 WATER/IPA | 100% Mineral Oil | 100% Soybean Oil |
| EXAMPLE | (seconds) | (seconds) | (seconds) |
| Untreated Leather | 0 | 0 | 0 |
| Comparative D | | | |
| Leather Treated at 1.5% SOF | 20 | 22 | 24 |
| with Copolymer Example 21 | | | |
| (Dried 10 minutes at 200° C. | | | |
| Leather Treated at 1.5% SOF | 10 | 0 | 10 |
| with Copolymer Example 21 | | | |
| (Dried overnight at RT) | | | |
| Untreated Suede | 0 | 0 | 0 |
| Comparative E | | | |
| Suede Treated at 1.5% SOF | >60 | 12 | 16 |
| with Copolymer Example 21 | | | |
| (Dried overnight at RT) | | | |

Copolymer compositions were also coated on other substrates such as polyethylene terephthalate (PET) film. A 5 wt. % solution of the copolymers was made by diluting the 28.6% solids polymers in EtOAc with PGME. Coatings were made on 5 mil (0.13 mm) primed PET film (obtained from 3M Company, St. Paul, MN, under trade designation SCOTCHPAK). The coating was done using a #4 (0.6 micron wet film thickness) wire wound rod (available from R.D. Specialties, Webster NY). Two coatings were prepared with each copolymer in Table 12, where one was dried at room temperature (RT) and one was dried at 120° C. for 30 minutes, to compare the effect of drying conditions on the contact angle. Contact angles of the coated copolymers on PET are shown in Table 12.

TABLE 12

| | | Water | | Hexadecane | |
|---|---|---|---|---|---|
| | Cure | Advancing, | Receding, | Advancing, | Receding, |
| EXAMPLE | Conditions | degrees | degrees | degrees | degrees |
| Uncoated PET | None | 79 | 55 | <20 | <20 |
| Comparative | | | | | |
| Example F | | | | | |
| Copolymer 35 | Room | 126 | <30 | 57 | <20 |
| in Table 6 | Temperature | | | | |
| Copolymer 36 | | 118 | <30 | 37 | <20 |
| in Table 6 | | | | | |
| Copolymer 35 | 120° C. for | 125 | <30 | 60 | <20 |
| in Table 6 | 30 Minutes | | | | |
| Copolymer 36 | | 117 | <30 | 41 | <20 |
| in Table 6 | | | | | |

The preceding description, given in order to enable one of ordinary skill in the art to practice the claimed disclosure, is not to be construed as limiting the scope of the disclosure, which is defined by the claims and all equivalents thereto.

1. A copolymer preparable by copolymerization of monomer components comprising:
a) at least one polydimethylsiloxane mono(meth)acrylate having a molecular weight of from 300 to 10000 grams/mole;
b) optionally at least one C₃-C₁₀ carboxylic acid-functional mono(meth)acrylate or a salt thereof;
c) at least one C₅-C₁₆ hydroxyalkyl mono(meth)acrylate; and
d) at least one of:
i) at least one C₁₀-C₃₀ linear alkyl mono(meth)acrylate optionally having one or two carbon atoms replaced by O or S, with the proviso that no O—O, S—S, or S—O bonds are present; or
ii) at least one (meth)acrylate represented by the formula 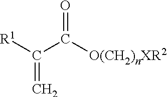
wherein:
each R¹ is independently H or a C₁-C₄ alkyl group;
each n is independently an integer from 0 to 18, inclusive;
each X is independently O, S, C₂-C₆ oxyalkylenoxy, C₂-C₆ thioalkylenethio, or a covalent bond, with the proviso that if n=0, then X is a covalent bond; and
each R² is independently a C₅-C₅₀ hydrocarbyl group optionally having 1 to 3 rings optionally collectively bound to one to four C₁-C₄ alkyl groups.

2. The copolymer of claim 1, wherein the monomer components comprise: 5 to 35 weight percent of monomer component a); 0 to 12 weight percent of monomer component b); 5 to 30 weight percent of monomer component c); and 40 to 70 weight percent of monomer component d), wherein monomer components a)-d) combined equals 100 weight percent.

3. The copolymer of claim 1, wherein the monomer components comprise: 10 to 30 weight percent of monomer component a); 4 to 10 weight percent of monomer component b); 10 to 20 weight percent of monomer component c); and 45 to 65 weight percent of monomer component d), wherein monomer components a)-d) combined equals 100 weight percent.

4. The copolymer of claim 1, wherein the monomer components comprise: 15 to 25 weight percent of monomer component a); 5 to 9 weight percent of monomer component b); 15 to 20 weight percent of monomer component c); and 50 to 60 weight percent of monomer component d), wherein monomer components a)-d) combined equals 100 weight percent.

5. The copolymer of claim 1, wherein the at least one polydimethylsiloxane mono(meth)acrylate has a molecular weight of from 600 to 7000 grams/mole.

6. The copolymer of claim 1, wherein the at least one of a C₃-C₁₀ carboxylic acid-functional mono(meth)acrylate is present and comprises (meth)acrylic acid.

7. The copolymer of claim 1, wherein the at least one C₅-C₁₆ hydroxyalkyl mono(meth)acrylate comprises at least one of hydroxypropyl (meth)acrylate or hydroxybutyl (meth)acrylate.

8. The copolymer of claim 1, wherein the at least one C₁₀-C₃₀ linear alkyl mono(meth)acrylate comprises at least one of octadecyl (meth)acrylate or behenyl (meth)acrylate.

9. The copolymer of claim 1, wherein each n is independently an integer from 6 to 18, inclusive.

10. The copolymer of claim 9, wherein each R² is independently a C₅-C₅₀ hydrocarbyl group having 1 to 3 rings collectively bound to a total of one or two C₁-C₄ alkyl groups.

11. A method of making a copolymer, the method comprising:
combining a free-radical initiator with monomer components comprising:
a) at least one polydimethylsiloxane mono(meth)acrylate having a molecular weight of from 300 to 10000 grams/mole;
b) optionally at least one C₃-C₁₀ carboxylic acid-functional mono(meth)acrylate or a salt thereof;
c) at least one C₅-C₁₆ hydroxyalkyl mono(meth)acrylate; and
d) at least one of:
i) at least one C₁₀-C₃₀ linear alkyl mono(meth)acrylate optionally having one or two carbon atoms replaced by O or S, with the proviso that no O—O, S—S, or S—O bonds are present; or
ii) at least one (meth)acrylate represented by the formula 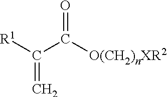
wherein:
each R¹ is independently H or a C₁-C₄ alkyl group;
each n is independently an integer from 0 to 18, inclusive;
each X is independently O, S, C₂-C₆ oxyalkylenoxy, C₂-C₆ thioalkylenethio, or a covalent bond, with the proviso that if n=0, then X is a covalent bond; and
each R² is independently a C₅-C₅₀ hydrocarbyl group optionally having 1 to 3 rings optionally collectively bound to one to four C₁-C₄ alkyl groups; and
decomposing the free-radical initiator and causing copolymerization of the monomer components.

12. The method of claim 11, wherein the monomer components comprise: 3 to 30 weight percent of monomer component a); 4 to 10 weight percent of monomer component b); 5 to 20 weight percent of monomer component c); and 6 to 60 weight percent of monomer component d), wherein monomer components a)-d) combined equals 100 weight percent.

13-18. (canceled)

19. A water-repellent article comprising a substrate having a non-fluorinated water-repellent treatment on at least a portion thereof, wherein the non-fluorinated water-repellent treatment comprises a copolymer of monomer components comprising:
a) at least one polydimethylsiloxane mono(meth)acrylate having a molecular weight of from 300 to 10000 grams/mole;
b) optionally at least one C₃-C₁₀ carboxylic acid-functional mono(meth)acrylate or a salt thereof;
c) at least one C₅-C₁₆ hydroxyalkyl mono(meth)acrylate; and
d) at least one of:
i) at least one C₁₀-C₃₀ linear alkyl mono(meth)acrylate optionally having one or two carbon atoms replaced by O or S, or
ii) at least one (meth)acrylate represented by the formula 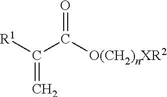
wherein:
each R¹ is independently H or a C₁-C₄ alkyl group;
each n is independently an integer from 0 to 18, inclusive;
each X is independently O, S, C₂-C₆ oxyalkylenoxy, C₂-C₆ thioalkylenethio, or a covalent bond, with the proviso that if n=0, then X is a covalent bond; and
each R² is independently a C₅-C₅₀ hydrocarbyl group optionally having 1 to 3 rings optionally collectively bound to one to four C₁-C₄ alkyl groups.

20. The water-repellent article of claim 19, where the non-fluorinated water-repellent treatment further comprises at least one additional component capable of promoting interaction of the non-fluorinated water-repellent treatment with the substrate.

21-25. (canceled)

26. The water-repellent article of claim 19, wherein the monomer components comprise: 5 to 35 weight percent of monomer component a); 0 to 12 weight percent of monomer component b); 5 to 30 weight percent of monomer component c); and 40 to 70 weight percent of monomer component d), wherein monomer components a)-d) combined equals 100 weight percent.

27. The water-repellent article of claim 19, wherein the monomer components comprise: 10 to 30 weight percent of monomer component a); 4 to 10 weight percent of monomer component b); 10 to 20 weight percent of monomer component c); and 45 to 65 weight percent of monomer component d), wherein monomer components a)-d) combined equals 100 weight percent.

28. The water-repellent article of claim 19, wherein the monomer components comprise: 15 to 25 weight percent of monomer component a); 5 to 9 weight percent of monomer component b); 15 to 20 weight percent of monomer component c); and 50 to 60 weight percent of monomer component d), wherein monomer components a)-d) combined equals 100 weight percent.

29. The water-repellent article of claim 19, wherein the at least one polydimethylsiloxane mono(meth)acrylate has a molecular weight of from 600 to 7000 grams/mole.

30. The water-repellent article of claim 19, wherein the at least one of a C₃-C₁₀ carboxylic acid-functional mono(meth)acrylate is present and comprises (meth)acrylic acid.

31-34. (canceled)

35. A monomer represented by the formula 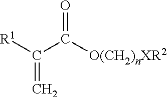
wherein:
each R¹ is independently H or a C₁-C₄ alkyl group;
each n is independently an integer from 4 to 18, inclusive;
each X is independently O, S, C₂-C₆ oxyalkylenoxy, C₂-C₆ thioalkylenethio, or a covalent bond; and
each R² is independently a C₅-C₅₀ hydrocarbyl group having 1 to 3 rings collectively bound to a total of one to four C₁-C₄ alkyl
